(19) United States
(12) Patent Application Publication
(10) Pub. No.: US 2020/0095168 A1
(43) Pub. Date: Mar. 26, 2020

(54) HIGH PORE VOLUME TITANIUM DIOXIDE CERAMIC MATERIALS AND METHODS OF MAKING THEREOF

(71) Applicant: Saint-Gobain Ceramics & Plastics, Inc., Worcester, MA (US)

(72) Inventors: Tritti Siengchum, Peninsula, OH (US); James M. Ralph, Copley, OH (US)

(21) Appl. No.: 16/572,796

(22) Filed: Sep. 17, 2019

Related U.S. Application Data
(60) Provisional application No. 62/734,569, filed on Sep. 21, 2018.

(51) Int. Cl. C04B 35/46; C04B 38/00

(52) U.S. Cl. CPC C04B 35/46; C04B 38/0038; C04B 2235/449; C04B 2235/445; C04B 2201/50

(57) ABSTRACT

Process for manufacturing a high pore volume titanium dioxide ceramic material using a fluoride source. Addition of fluoride in varying amounts modulates the properties of the ceramic material by increasing the pore volume while maintaining a relatively high crush strength. Resulting porous ceramic material include a plurality of sintered ceramic titanium dioxide particles having at least 10% (w/w) rutile phase and exhibiting a pore volume (PV) between 0.20 and 0.60 mL/g and a crush strength (CS) of no less than 3 lbf (13.35 N). The porous ceramic materials described herein can be used as catalyst carriers. The ceramic material can be used as carrier for various catalysts, for example Fisher-Tropsch catalysts.

### CROSS-REFERENCE TO RELATED APPLICATION

This application claims the benefit of U.S. Provisional Application No. 62/734,569 filed Sep. 21, 2013.

### FIELD OF THE INVENTION

The present disclosure relates generally to a process for making titanium dioxide porous ceramic materials, the process including titanium dioxide mineralization using a fluoride source. The disclosure also relates to a porous ceramic material comprising a plurality of sintered ceramic titanium dioxide particles having at least 10% (w/w %) rutile phase, the material exhibiting a pore volume (PV) between 0.20 and 0.60 mL/g and a crush strength (CS) of no less than 3 lbf (13.35 N). The porous ceramic materials described herein can be used as a catalyst carrier.

### BACKGROUND OF THE INVENTION

Titanium dioxide (titania) based carriers are used to support catalyst compositions that are typically exposed to elevated temperatures in use. Carrier materials are commonly produced by mixing a titania powder with a temporary binder formulation until an extrudable paste is formed, then forming the paste into the desired shape, drying the shape, and firing to burn out the temporary binder and to convert the titania to a solid stable material. The titania carrier can be obtained in the shape of pellets, or individual relatively small, ring-based shaped structures, such as “wagon wheels,” or any other extruded shapes with constant cross-sections (as a result of extruding a continuous rod and then cutting the rod into pellets of the desired size), or large honeycomb monoliths. While high firing temperatures can yield materials with good attrition resistance and corrosion resistance, the high firing temperatures are also associated with low pore volumes and surface areas, thus making the materials less suited for catalyst supports. There is therefore a need in the art for novel titanium dioxide ceramic materials for use as catalyst carriers.

### SUMMARY OF THE INVENTION

One embodiment relates to a porous ceramic material including a plurality of sintered ceramic titanium dioxide particles, the material having a pore volume (PV) between 0.20 and 0.60 mL/g and a crush strength (CS) of no less than 3 lbf (13.35 N), wherein at least 10% (weight percent or w/w %) of the titanium dioxide is rutile phase. In some embodiments, the crush strength is between 3 lbf (13.35 N) and 100 lbf (444.82 N). In some embodiments, the crush strength is at least 35 lbf (155.69 N). In some embodiments, the crush strength is at least 50 lbf (222.41 N). In some embodiments, at least 10% (w/w %) of the titanium dioxide is rutile phase. In some embodiments, at least 15% (w/w %) of the titanium dioxide is rutile phase. In some embodiments, at least 35% (w/w %) of the titanium dioxide is rutile phase. In some embodiments, at least 50% (w/w %) of the titanium dioxide is rutile phase. In some embodiments, up to 100% (w/w %) of the titanium dioxide is rutile phase. In some embodiments, the material has a surface area between 2 and 10 m²/g. In some embodiments, the material includes pores with a diameter between 0.02 and 0.40 μm. In some embodiments, the material has a median pore diameter of between 0.15 and 0.20 μm.

One embodiment relates to a porous ceramic material including a plurality of sintered ceramic titanium dioxide particles, the material having a pore volume (PV) between 0.20 and 0.50 mL/g and a crush strength (CS) between 5 lbf (22.24 N) and 35 lbf (155.69 N), and wherein at least 14% of the titanium dioxide is rutile phase. In some embodiments, at least 35% of the titanium dioxide is rutile phase. In some embodiments, at least 80% of the titanium dioxide is rutile phase. In some embodiments, up to 99% of the titanium dioxide is rutile phase. In some embodiments, up to 100% of the titanium dioxide is rutile phase.

One embodiment relates to a process of making a porous ceramic material, the process including the steps of: preparing a mixture comprising (w/w %): titanium dioxide (45% to 70%), water (10% to 40%), a fluoride source (2% to 15%), and an acid (1% to 7.5%); and sintering the mixture. In some embodiments, the fluoride source is ammonium bifluoride. In some embodiments, the mixture includes between 2.5% and 6% of the fluoride source. In some embodiments, the mixture includes about 2.8% of the fluoride source. In some embodiments, the mixture includes about 4.4% of the fluoride source. In some embodiments, the mixture includes about 5.6% of the fluoride source. In some embodiments, the mixture includes about 5.9% of the fluoride source. In some embodiments, the mixture further includes one or more polymers or copolymers selected from hydroxypropyl methylcellulose, a vinyl chloride copolymer, a vinyl acetate copolymer, an olefin polymer, an olefin copolymer, polyethylene, polypropylene, polystyrene, polyvinyl alcohol, an ethylene-vinyl acetate copolymer, an ethylene-vinyl alcohol copolymer, a diene polymer, a diene copolymer, polybutadiene, an ethylene propylene diene monomers (EPDM) rubber, a styrene-butadiene copolymer, a butadiene acrylonitrile rubber, a polyamide, polyamide-6, polyamide-66, a polyester, polyethylene terephthalate, a hydrocarbon polymer, a polyolefin, and polypropylene. In some embodiments, the mixture further includes one or more naturally occurring thermally decomposable materials. In some embodiments, the acid is formic acid. In some embodiments, the process further includes extruding the mixture before sintering. In some embodiments, the process further includes forming the mixture into one or more discrete bodies before sintering. In some embodiments, the process further includes drying the mixture. In some embodiments, the process further includes heating the mixture at a temperature of at least 900° C. In some embodiments, the process further includes heating the mixture at a temperature of up to 1100° C. In some embodiments, the process further includes heating the mixture at a temperature of between about 950° C. and about 1050° C. In some embodiments, the process further includes heating the mixture at a temperature of about 950° C., about 1000° C., or about 1050° C.

One embodiment relates to a process of making a porous ceramic material, the process including the steps of: preparing a mixture comprising (w/w %): titanium dioxide (50% to 55%), water (10% to 40%), a fluoride source (2.8% to 5.9%), formic acid (2% to 5%), and a polymer or copolymer; extruding and forming the mixture into one or more discrete bodies; and sintering the mixture at a temperature of between about 950° C. and about 1050° C. In some embodiments, the mixture includes about 2.8% of the fluoride source. In some embodiments, the mixture includes about 4.4% of the fluoride source. In some embodiments, the mixture includes about 5.6% of the fluoride source. In some embodiments, the mixture includes about 5.9% of the fluoride source. In some embodiments, the polymers or copolymer is selected from hydroxypropyl methylcellulose, a vinyl chloride copolymer, a vinyl acetate copolymer, an olefin polymer, an olefin copolymer, polyethylene, polypropylene, polystyrene, polyvinyl alcohol, an ethylene-vinyl acetate copolymer, an ethylene-vinyl alcohol copolymer, a diene polymer, a diene copolymer, polybutadiene, an ethylene propylene diene monomers (EPDM) rubber, a styrene-butadiene copolymer, a butadiene acrylonitrile rubber, a polyamide, polyamide-6, polyamide-66, a polyester, polyethylene terephthalate, a hydrocarbon polymer, a polyolefin, and polypropylene. In some embodiments, the mixture further includes one or more naturally occurring thermally decomposable materials.

### BRIEF DESCRIPTION OF THE DRAWINGS

The foregoing summary, as well as the following detailed description of the invention, will be better understood when read in conjunction with the appended drawings.

FIG. 1 shows the pore volume (cc/g) vs. % rutile in five embodiments of the inventive titanium dioxide ceramic material carriers (represented by squares) compared to four comparative examples of titanium dioxide ceramic material carriers made without the use of ammonium bifluoride (represented by triangles).

FIG. 2 shows a device used to measure the crush strength of ceramic material pellets made as described herein.

### DETAILED DESCRIPTION OF THE INVENTION

High pore volume titanium dioxide ceramic materials and methods of making thereof are disclosed. The ceramic materials have also relatively high surface areas and high crush strengths. In some embodiments, the ceramic materials can be used in various applications, including catalyst carrier applications, for example gas to liquid catalyst applications, and as carriers for a Fisher-Tropsch catalyst. The ceramic materials are manufactured in a titanium dioxide mineralization process, which results in an elevated pore volume material without detracting from its mechanical properties, i.e., maintaining crush strength values suitable for catalyst carrier applications.

As described herein, a source of fluoride is used in the titanium dioxide mineralization processes. In some embodiments, ammonium bifluoride (ABF) is added to the greenware mix in place of water in a second liquid addition step in the TiO₂ slurry mixing procedure. In some embodiments, the greenware is fired in a fluorine atmosphere. In some embodiments, firing can be performed in a static kiln. In some embodiments, firing can be performed. In a rotary kiln. In some embodiments, the firing temperature is in a range of about 900° C. to about 1100° C.

As described herein, fluoride-mineralized titanium dioxide carriers may be prepared by calcining titanium dioxide, for example amorphous titanium dioxide, in the presence of a fluoride mineralizing agent. The particular mineralization manner is not limited, and any method known in the art may be used, such as those methods described in U.S. Pat. Nos. 3,950,507, 4,379,134, 4,994,588, 4,994,589, and 6,203,773, and U.S. Patent Pub. No. 2012/0108832, all of which are incorporated herein by reference for descriptions relating to the mineralization of a metal oxide.

Without wishing to be bound by any particular theory, it is believed that as described herein, the use of a fluoride source in a process of making a titanium dioxide ceramic material affords a higher percentage of rutile phase titanium dioxide in the ceramic material comparative to a ceramic material made without the use of fluoride source.

In some embodiments, aspects of the present embodiment are directed to a process for forming a shaped article containing titania and to a titania-containing shaped article. The shaped article may be used as a catalyst carrier, i.e., a support for a catalyst, or as a catalyst itself. In some embodiments, the materials described herein are suited for use in applications where chemical corrosion resistance and attrition resistance are desirable. Titania and titanium dioxide are used interchangeably herein to refer to a titanium oxide which may be stoichiometric (TiO₂), or non-stoichiometric, unless otherwise noted.

In some embodiments, the catalytic applications for the exemplary catalyst carrier favor the use of high surface area catalyst supports. While conventional methods can achieve this by firing to moderately high temperatures to convert the titania to its anatase form, it has been found that, in some embodiments, such carriers tend to have little mechanical strength, little attrition resistance, and/or little corrosion resistance. Without wishing to be bound by any particular theory, it is believed that conventionally, higher temperatures favor formation of rutile, yielding higher attrition and corrosion resistance, but at the expense of decreases in pore volume and surface area.

In one embodiment, the present method enables moderately high firing temperatures to be used for generating carriers with comparable or better pore volumes and surface areas than those conventionally produced at similar firing temperatures, while providing higher mechanical strength, corrosion resistance, and attrition resistance, which are normally associated with much higher firing temperatures.

One embodiment relates to a porous ceramic material including a plurality of sintered ceramic titanium dioxide particles, the material having a pore volume (PV) between 0.2.0 and 0.60 mL/g and a crush strength (CS) of no less than 3 lbf (13.35 N), wherein at least 10% (w/w %) of the titanium dioxide is rutile phase. In one embodiment, the invention relates to a porous ceramic material including a plurality of sintered ceramic titanium dioxide particles, the material having a pore volume (PV) between 0.20 and 0.50 mL/g and a crush strength (CS) between 5 lbf (22.24 N) and 35 lbf (155.69 N), and wherein at least 14% of the titanium dioxide is rutile phase. In some embodiments, at least 35% of the titanium dioxide is rutile phase. In some embodiments, at least 80% of the titanium dioxide is rutile phase. In some embodiments, up to 99% of the titanium dioxide is rutile phase. In some embodiments, up to 100% of the titanium dioxide is rutile phase.

The rutile and anatase contents of the ceramic material can be measured by X-ray diffraction. As used herein, the rutile and anatase contents of the ceramic material are measured using a Panalytical X-Ray Diffractometer, where the content of anatase in the titania ceramic material was determined by Panalytical X'Pert Highscore software. Relevant measuring parameters were, for example, scan: 5-90 2 theta°; step size: 0.02 theta°; step time: 2 seconds; fixed slits; and sample rotation. Sample identification was made using ICDD numbers 76-0649 for rutile and 71-1166 for anatase. If the Panalytical Method fails to identify an anatase pattern, the percent anatase is reported as <3%, and XRD analysis of anatase content less than 3% is determined by the Rietveld method if necessary. The Rietveld analysis uses the algorithm: X'PERT PLUS Rietveld, which is based on the source codes of the program LHPM1 (Apr. 11, 1988) of R. J. Hill and C. J. Howard, which in turn is a successor of the program DBW3.2 from D. B. Wiles and R. A. Young. In principle the Rietveld method is based on the equation:

$${Y}_{ic} = {Y}_{ib} + {\sum }_{p} {\sum }_{k = {k}_{1}^{p}}^{{k}_{2}^{p}} {G}_{ik}^{p} {I}_{k}$$

where Y_{ic} is the net intensity calculated at point i in the pattern. Y_{ib} is the background intensity, Gᵢₖ is a normalized peak profile function, Iₖ is the intensity of the kth Bragg reflection, k₁ . . . k₂ are the reflections contributing intensity to point i, and the superscript p corresponds to the possible phases present in the sample. The intensity Iₖ is given by the expression:

Iₖ=SMₖLₖ|Fₖ|²Pₖ

where S is the scale factor, Mₖ is the multiplicity, is the Lorentz polarization factor, and Fₖ is the structure factor,

$${F}_{k} = {\sum }_{j = 1}^{n} {f}_{j} exp [ 2 π i ( {h}_{r}^{t} {r}_{j} - {h}_{k}^{t} {B}_{j} {h}_{K} ) ]$$

where fⱼ is the scattering factor or scattering length of atom j, and hₖ, rⱼ, and Bⱼ are matrices representing the Miller indices, atomic co-ordinates and anisotropic thermal vibration parameters, respectively, and the superscript t indicates matrix transposition. The factor Fₖ is used to describe the effects of preferred orientation: no preferred orientation is indicated with Fₖ=1. The positions of the Bragg peaks from each phase are determined by their respective set of cell dimensions, in conjunction with a zero parameter and the wavelength provided. All of these parameters except the wavelength, may be refined simultaneously with the profile and crystal structure parameters. The ratio of the intensities for two possible wavelengths is included in the calculation of |Fₖ|², so that only a single scale factor for each phase is required. This ratio cannot be refined.

In some embodiments, at least 10% (w/w %) of the titanium dioxide is rutile phase. In some embodiments, at least 15% (w/w %) of the titanium dioxide is rutile phase. In some embodiments, at least 35% (w/w %) of the titanium dioxide is rutile phase. In some embodiments, at least 50% (w/w %) of the titanium dioxide is rutile phase. In some embodiments, up to 100% (w/w %) of the titanium dioxide is rutile phase.

In some embodiments, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29%, at least 30%, at least 31%, at least 32%, at least 33%, at least 34%, at least 35%, at least 36%, at least 37%, at least 38%, at least 39%, at least 40%, at least 41%, at least 42%, at least 43%, at least 44%, at least 45%, at least 46%, at least 47%, at least 48%, at least 49%, at least 50%, at least 51%, at least 52%, at least 53%, at least 54%, at least 55%, at least 56%, at least 57%, at least 58%, at least 59%. at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% of the titanium dioxide is rutile phase (w/w %).

In some embodiments, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or about 100% of the titanium dioxide is rutile phase (w/w %).

The total pore volume, the median pore diameter, and the pore size distribution of a carrier may be measured by a conventional mercury intrusion porosimetry device in which liquid mercury is forced into the pores of a carrier. Greater pressure is needed to force the mercury into the smaller pores and the measurement of pressure increments corresponds to volume increments in the pores penetrated and hence to the size of the pores in the incremental volume. As used herein, the pore size distribution, the median pore diameter and the pore volumes are as measured by mercury intrusion porosimetry to a pressure of 4.1×10⁸Pa using a Micromeritics® Autopore™ IV 9500 automated mercury porosimeter (130° contact angle, mercury with a surface tension of 0.480 N/m, and correction for mercury compression applied). As used herein, the median pore diameter is understood to mean the pore diameter corresponding to the point in the pore size distribution at which 50% of the total pore volume is found in pores having less than (or greater than) said point.

In some embodiments, the invention relates to a titanium dioxide ceramic material having a pore volume of about 0.20 mL/g, about 0.21 mL/g, about 0.22. mL/g, about 0.23 mL/g, about 0.24 mL/g, about 0.25 mL/g, about 0.26 mL/g, about 0.27 mL/g, about 0.28 mL/g, about 0.29 mL/g, 0.30 mL/g, about 0.31 mL/g, about 0.32 mL/g, about 0.33 mL/g, about 0.34 mL/g, about 0.35 mL/g, about 0.36 mL/g, about 0.37 mL/g, about 0.38 mL/g, about 0.39 mL/g, 0.40 mL/g, about 0.41 mL/g, about 0.42 mL/g, about 0.43 mL/g, about 0.44 mL/g, about 0.45 mL/g, about 0.46 mL/g, about 0.47 mL/g, about 0.48 mL/g, about 0.49 mL/g, 0.50 mL/g, about 0.51 mL/g, about 0.52 mL/g, about 0.53 mL/g, about 0.54 mL/g, about 0.55 about 0.56 mL/g, about 0.57 mL/g, about 0.58 mL/g, about 0.59 mL/g, or about 0.60 mL/g.

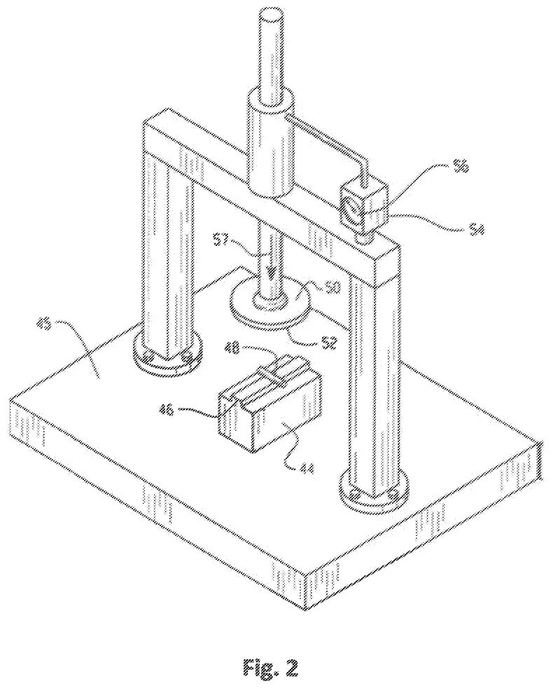

An embodiment of a formed, porous ceramic body of this invention that may be used as a carrier for a catalyst has a crush strength of at least 3 lbf (13.35 N) when tested as a pellet, for example an elongated cylindrically shaped pellet with a length of from about 4 mm to about 8 mm, and an average diameter of about 3 mm. Crush strengths were measured using the device depicted in FIG. 2. With reference to FIG. 2, the crush strength of a pellet is determined as follows. Begin by placing steel block 44, also known as an anvil, on a solid and level surface 45 such as the top of a workbench. A suitable anvil measures about 2.0 cm wide by about 2.0 cm deep by about 4.0 cm long. One of the block's surfaces that measures about 2.0 cm by about 4.0 cm contains a raised platform 46 which is about 0.6 cm wide, about 0.3 cm high, and extends along the length of the steel block's surface. Pellet 48 is placed on the raised platform so that the length of the pellet is perpendicular to the raised portion of the anvil and parallel to the surface of the workbench. Movable platen 50 has a flat surface 52 that measures approximately 3.5 cm in diameter and is oriented parallel to the surface of the workbench, and is positioned directly above the anvil onto which the pellet has been placed. The platen is equipped with a load cell 54 that measures the pressure exerted by the platen. Pressure recording device 56 is connected to the load cell. A pellet's crush strength is determined by the operator activating the testing apparatus thereby causing the platen to travel downwardly, see arrow 57, toward the pellet at a rate of about 1.2 cm per minute until the platen contacts and then crushes the pellet across the raised platform. The load cell and recording device cooperate to detect and record the pressure exerted on the pellet during the crushing action. If a formed, porous ceramic body is not shaped as a pellet, the crush strength of the ceramic body may be determined by obtaining the raw materials used to make the ceramic body, then forming a pellet and using the test procedure described. above. Since the crush strength values are influenced by the shape and size of the ceramic body when it is crushed, the only body that should be crushed is an elongated pellet that measures. about 3 mm in diameter and about 4 mm to about 8 mm in length. To determine the average crush strength of a plurality of pellets, measure the crush strength of a number of separate, randomly-selected pellets, for example twenty pellets, and then calculate their average value.

As reported herein, all crush strengths were measured in English units (lbf) and metric units for crush strength are calculated values from the measured English units. In some embodiments, the crush strength is between about 3 lbf (13.35 N) and about 35 lbf (155.69 N).

In some embodiments, the crush strength is between 3 and 35 lbf. In some embodiments, the crush strength is about 3 lbf, about 3.5 lbf, about 4 lbf, about 4.5 lbf, about 5 lbf, about 5.5 lbf, about 6 lbf, about 6.5 lbf, about 7 lbf, about 7.5 lbf, about 8 lbf, about 8.5 lbf, about 9 lbf, about 9.5 lbf, about 10 lbf, about 10.5 lbf, about 11 lbf, about 11.5 lbf, about 12 lbf, about 12.5 lbf, about 1.3 lbf, about 13.5 lbf, about 14 lbf, about 14.5 lbf, about 15 lbf, about 15.5 lbf, about 16 lbf, about 16.5 lbf, about 17 lbf, about 17.5 lbf, about 18 lbf, about 18,5 lbf, about 19 lbf, about 19.5 lbf, about 20 lbf, about 20.5 lbf, about 21 lbf, about 21.5 lbf, about 22 lbf, about 22.5 lbf, about 23 lbf, about 23.5 lbf, about 24 lbf, about 24.5 lbf, about 25 lbf, about 25.5 lbf, about 26 lbf, about 26.5 lbf, about 27 lbf, about 27.5 lbf, about 28 lbf, about 28.5 lbf, about 29 lbf, about 29.5 lbf, about 30 lbf, about 30.5 lbf, about 31 lbf, about 31.5 lbf, about 32 lbf, about 32.5 lbf, about 33 lbf, about 33.5 lbf, about 34 lbf, about 34.5 lbf, or about 35 lbf.

In some embodiments, the crush strength is between about 13 N and about 225 N. In some embodiments, the crush strength is between about 13 N and about 445 N. In some embodiments, the crush strength is about 13 N, about 14 N, about 15 N, about 16 N, about 17 N, about 18 N, about 19 N, about 20 N, about 21 N, about 22 N, about 23 N, about 24 N, about 25 N, about 26 N, about 27 N, about 28 N, about 29 N, about 30 N, about 31 N, about 32 N, about 33 N, about 34 N, about 35 N, about 36 N, about 37 N, about 38 N, about 39 N, about 40 N, about 41 N, about 42 N, about 43 N, about 44 N, about 45 N, about 46 N, about 47 N, about 48 N, about 49 N, about 50 N, about 51 N, about 52 N, about 53 N, about 54 N, about 55 N, about 56 N, about 57 N, about 58 N, about 59 N, about 60 N, about 61 N, about 62 N, about 63 N, about 64 N, about 65 N, about 66 N, about 67 N, about 68 N, about 69 N, about 70 N, about 71 N, about 72 N, about 73 N, about 74 N, about 75 N, about 76 N, about 77 N, about 78 N, about 79 N, about 80 N, about 81 N, about 82 N, about 83 N, about 84 N, about 85 N, about 86 N, about 87 N, about 88 N, about 89 N, about 90 N, about 91 N, about 92 N, about 93 N, about 94 N, about 95 N, about 96 N, about 97 N, about 98 N, about 99 N, about 100 N, about 101 N, about 102 N, about 103 N, about 104 N, about 105 N, about 106 N, about 107 N, about 108 N, about 109 N, about 110 N, about 111 N, about 112 N, about 113 N, about 114 N, about 115 N, about 116 N, about 117 N, about 118 N, about, 119 N, about 120 N, about 121 N, about 122 N, about 123 N, about 124 N, about 125 N, about 126 N, about 127 N, about 128 N, about 129 N. about 130 N, about 131 N, about 132 N, about 133 N, about 134 N, about 135 N, about 136 N, about 137 N, about 138 N, about 139 N, about 140 N, about 141 N, about 142 N, about 143 N, about 144 N, about 145 N, about 146 N, about 147 N, about 148 N, about 149 N, about 150 N, about 151 N, about 152 N, about 153 N, about 154 N, about 155 N, or about 156 N.

In some embodiments, the crush strength is between about 155 N and about 165 N. In some embodiments, the crush strength is between about 165 N and about 175 N. In some embodiments, the crush strength is between about 175 N and about 185 N. In some embodiments, the crush strength is between about 185 N and about 195 N. In some embodiments, the crush strength is between about 195 N and about 205 N. In some embodiments, the crush strength is between about 205 N and about 215 N. In some embodiments, the crush strength is between about 215 N and about 225 N. In some embodiments, the crush strength is between about 225 N and about 235 N. In some embodiments, the crush strength is between about 235 N and about 245 N. In some embodiments, the crush strength is between about 245 N and about 255 N. In some embodiments, the crush strength is between about 255 N and about 265 N. In some embodiments, the crush strength is between about 265 N and about 275 N. In some embodiments, the crush strength is between about 275 N and about 285 N. In some embodiments, the crush strength is between about 285 N and about 295 N. In some embodiments, the crush strength is between about 305 N and about 315 N. In some embodiments, the crush strength is between about 315 N and about 325 N. In some embodiments, the crush strength is between about 325 N and about 335 N. In some embodiments, the crush strength is between about 335 N and about 345 N. In some embodiments, the crush strength is between about 345 N and about 355 N. In some embodiments, the crush strength is between about 355 N and about 365 N. In some embodiments, the crush strength is between about 365 N and about 375 N. In some embodiments, the crush strength is between about 375 N and about 385 N. In some embodiments, the crush strength is between about 385 N and about 395 N. In some embodiments, the crush strength is between about 395 N and about 405 N. In some embodiments, the crush strength is between about 405 N and about 415 N. In some embodiments, the crush strength is between about 415 N and about 425 N. In some embodiments, the crush strength is between about 425 N and about 435 N. In some embodiments, the crush strength is between about 435 N and about 445 N.

“Surface area” as used herein is understood to relate to the surface area as determined. by the B.E.T. (Brunauer, Emmett and Teller) method as described in journal of the American Chemical Society, 1938, 60, pp. 309-316. High surface area carriers provide improved performance and stability of operation in catalyst carrier applications. In some embodiments, the titanium dioxide ceramic material has a surface area between 2 and 10 m²/g. In some embodiments, the titanium dioxide ceramic material has a surface area of about 2.0 m²/g, about 2.1 m²/g, about 2.2 m²/g, about 2.3 m²/g, about 2.4 m²/g, about 2.5 m²/g, about 2.6 m²/g, about 2.7 m²/g, about 2.8 m²/g, about 2.9 m²/g, about 3.0 m²/g, about 3.1 m²/g, about 3.2 m²/g, about 3.3 m²/g, about 3.4 m²/g, about 3.5 m²/g, about 3.6 m²/g, about 3.7 m²/g, about 3.8 m²/g, about 3.9 m²/g, about 4.0 m²/g, about 4.1 m²/g, about 4.2 m²/g, about 4.3 m²/g, about 4.4 m²/g, about 4.5 m²/g, about 4.6 m²/g, about 4.7 m²/g, about 4.8 m²/g, about 4.9 m²/g, about 5.0 m²/g, about 5.1 m²/g, about 5.2 m²/g, about 5.3 m²/g, about 5.4 m²/g, about 5.5 m²/g, about 5.6 m²/g, about 5.7 m²/g, about 5.8 m²/g, about 5.9 m²/g, about 6.0 m²/g, about 6.1 m²/g, about 6.2 m²/g, about 6.3 m²/g, about 6.4 m²/g, about 6.5 m²/g, about 6.6 m²/g, about 6.7 m²/g, about 6.8 m²/g, about 6.9 m²/g, about 7.0 m²/g, about 7.1 m²/g, about 7.2 m²/g, about 7.3 m²/g, about 7.4 m²/g, about 7.5 m²/g, about 7.6 m²/g, about 7.7 m²/g, about 7.8 m²/g, about 7.9 m²/g, about 8.0 m²/g, about 8.1 m²/g, about 8.2 m²/g, about 8.3 m²/g, about 8.4 m²/g, about 8.5 m²/g, about 8.6 m²/g, about 8.7 m²/g, about 8.8 m²/g, about 8.9 m²/g, about 9.0 m²/g, about 9.1 m²/g, about 9.2 m²/g, about 9.3 m²/g, about 9.4 m²/g, about 9.5 m²/g, about 9.6 m²/g, about 9.7 m²/g, about 9.8 m²/g, about 9.9 m²/g, or about 10.0 m²/g.

The carrier can have a high attrition resistance, e.g., less than 1% for 1.6 mm pellets as measured by ASTM D4058-96. This results in a catalyst which retains its integrity in situations where abrasive contact with adjacent catalyst particles or catalyst bodies occurs, and which withstands substantial compressive forces.

In some embodiments, the material includes pores with a diameter between 0.02 and 0.40 μm. In some embodiments, the material has a median pore diameter of between 0.15 and 0.20 μm.

In exemplary embodiments, a process of making a porous ceramic material described. herein includes the steps of: preparing a mixture comprising (w/w %): titanium dioxide (45% to 70%), water (10% to 40%), a fluoride source (2% to 15%), and an acid (1% to 7.5%); and sintering the mixture. In one embodiment, the process of making a porous ceramic material includes the steps of preparing a mixture comprising (w/w %): titanium dioxide (50% to 55%), water (10% to 40%), a fluoride source (2.8% to 5.9%), formic acid (2% to 5%), and a polymer or copolymer; extruding and forming the mixture into one or more discrete bodies; and sintering the mixture at a temperature of between about 950° C. and about 1050° C.

Any suitable source of titanium dioxide can be used. In some embodiments, the titanium dioxide used in a process described herein is amorphous titanium dioxide. In some embodiments, the titanium dioxide used in a process described herein is unhydrated titanium dioxide TiO₂. In some embodiments, the titanium dioxide used in a process described herein is titanium dioxide hydrate TiO₂.xH₂O. In some embodiments, the titanium dioxide used in a process described herein is titanium dioxide monohydrate TiO₂.H₂O. In some embodiments, the titanium dioxide used in a process described herein is any other titanium dioxide hydrate known in the art. One skilled in the art understands how the relevant ingredient amounts need to be modified when substituting a hydrated titania for an unhydrated titania, or vice versa. For example, if a process ingredient list calls for an amount of hydrated titania, substitution of the hydrated titania with an unhydrated titania is possible by reducing the amount of titania added by an amount relative to the degree of hydration, while at the same time increasing the amount of water, and/or other lubricants used in the process.

In some embodiments, the titanium dioxide includes titanium dioxide heat sinterable particles having a volume average particle size of from about 0.5 μm to about 100 μm. In some embodiments, the titanium dioxide particles have a volume average particle size of about 1 μm to about 80 μm. In some embodiments, particle size, for example volume average size, can be determined by laser scattering, for example by using the Horiba particle LA-950 laser scattering particle size distribution analyzer. The analyzer uses the principles of Mie scattering theory for measuring particle size and distribution in a range of 0.01 μm to 3000 μm. The method includes the use of reagents such as deionized water (DI) and a dispersant, for example 10% Darvan® C dispersant. After turning on the power, the unit is allowed to stabilize for a minimum of 15 minutes. Using LA-950 for Windows, “Conditions,” “Set conditions for next measurement,” a measurement dialog box is opened. Sample information is entered, and in the “Calculation Box” the type of material to be analyzed is chosen. The “Refractive Index Tab” allows choosing from materials that have already been created in the system. “Create” allows for creating a refractive index file for materials that are mixtures or that have not already been created. Before creating a new file, the refractive index of the material needs to be known. To create a new file, “Create” is chosen in the Refractive Index Tab. The name of the file and any comment is entered. In the “Sample” box the name of the material and the refractive index can be edited. In the “Dispersion” box the list to display the typical dispersion media can be selected. “Create” button is depressed after all information has been entered. After the Sample Information and Calculation type have been entered, “OK” is selected in the bottom of the Measurement Dialog Box. The second and third “hot” buttons switch between the “Measurement View” and the “Result Data View.” The “Measurement View” can be selected. The “Measurement View” has buttons that control the various functions of the LA-950. Depressing “Rinse” will rinse the system 3 times with water. Depressing “Feed” will fill the sample cell with a set amount of water. “Circulation” and “Agitation” are turned on. Depressing “De-Bubble” will remove any trapped air in the system; this step can be repeated. If the system has been idle, depressing “Alignment” realigns the laser path, and depressing “Blank” blanks the transmittance. About 3 drops of 10% Darvan® C are added, unless otherwise specified. The sample is slowly added until the transmittance graph is at minimum 98%. If the “Ultrasonic” is required, it can be turned on. When the sonic shuts off, “Measurement” is depressed. The sample result will automatically print after measurement, and the screen changes to “Result Data View.” From the “Result Data View” screen the data file can be saved in the appropriate folder. Depressing the “hot” button returns to “Measurement View.” Depressing “Drain” drains the system. Depressing “Rinse” rinses out the system. Various commercial dispersing aids, such as Calgon, sodium phosphate, formic acid, Daxad and Triton can be used. Samples of fine, highly agglomerated particles may be predispersed in dispersion fluid with an external ultrasonic probe and/or a stirrer, but care must be taken to obtain a representative sample. Refractive Indices may be obtained from the CRC or other reference materials. The approximate refractive index of a mixture may be calculated by multiplying the % fraction of the material by its refractive index and then adding the results. For example, a material that is 82% alumina and 18% silica would have an approximate refractive index of 1.725(0.82×1.765(RI alpha alumina)=1.447; 0.18×1.544(RI quartz)=0.278; 1.447+0.278=1.725).

In exemplary embodiments, a process of making a porous ceramic material described herein includes the steps of: preparing a mixture comprising about 45% (w/w %), about 46% (w/w %), about 47% (w/w %), about 48% (w/w %), about 49% (w/w %), about 50% (w/w %), about 51% (w/w %), about 52% (w/w %), about 53% (w/w %), about 54% (w/w %), about 55% (w/w %), about 56% (w/w %), about 57% (w/w %) about 58% (w/w %), about 59% (w/w %), about 60% (w/w %), about 61% (w/w %), about 62% (w/w %), about 63% (w/w %), about 64% (w/w %), about 65% (w/w %), about 66% (w/w %), about 67% (w/w %), about 68% (w/w %), about 69% (w/w %), or about 70% (w/w %) titanium dioxide.

In some embodiments, the fluoride source is ammonium bifluoride. In some embodiments, ammonium bifluoride can be used in any suitable form, for example as a 60% solution. One skilled in the art understands how the relevant ingredient amounts need to be modified when substituting an ammonium bifluoride solution for undiluted ammonium bifluoride, or vice versa. For example, if a process ingredient list calls for an amount of ammonium bifluoride solution, substitution of the ammonium bifluoride solution with undiluted ammonium bifluoride is possible by reducing the amount corresponding to ammonium bifluoride by an amount relative to the degree of dilution of the solution, while at the same time increasing the amount of water, and/or other lubricants used in the process.

Amounts of fluoride present in the fluoride-mineralized ceramic material carrier will vary depending upon the specific process conditions under which the fluoride-mineralized ceramic material carrier was made, e.g., calcining and/or sintering temperature, rate of heating, the type and amount of titanium dioxide used, calcination atmosphere, etc. Reference is made to, for example, Shaklee, et al, “Growth of α-Al₂O₃Platelets in the HF-γ-Al₂O₃ System,” Journal of the American Ceramic Society, 1994, Volume 77, No. 11, pp, 2977-2984 for further discussion relating to the effects of fluoride concentration on carrier properties. Thus, in some embodiments, the fluoride amounts refer to the amount of fluoride mineralizing agent used to prepare a fluoride-mineralized titanium dioxide ceramic material carrier, and do not necessarily reflect the amount that may ultimately be present in the fluoride-mineralized ceramic material carrier, as such.

A suitable fluoride mineralizing agent can be any material that is volatile or which can be readily volatilized under calcining and/or sintering conditions of the titanium dioxide used. In some embodiments, the fluoride mineralizing agent is capable of providing a volatile fluorine species at a temperature of about 1100° C. or less, about 1050° C. or less, about 1000° C. or less, about 950° C. or less, or 900° C. or less. Fluoride mineralizing agents may be organic or inorganic and may include ionic, covalent, and polar covalent compounds. The specific form in which a fluoride mineralizing agent is provided is not limited and therefore, a volatile fluorine species may include fluorine, fluoride ions, and fluorine-containing, compounds. Similarly, the fluoride mineralizing agent may be provided in gaseous or liquid solution, e.g., provided in the form of a solution comprising the fluoride mineralizing agent, or in gaseous form. Examples of suitable fluoride mineralizing agents include, but are not limited to, F₂, ammonium fluorides, such as ammonium bifluoride (NH₄HF₂) and ammonium fluoride (NH₄F), hydrogen fluoride, hydrofluoric acid, dichlorodifluoromethane (CCI₂F₂), silicon tetrafluoride (SiF₄), silicon hexafluoride ([SiF₆]²⁻), boron trifluoride (BF₃), nitrogen trifluoride (NF₃), xenon difluoride (XeF₂), sulfur hexafluoride (SF₅), phosphorous pentafluoride (PF₅), carbon tetrafluoride (CF₄), fluoroform (CHF₃), tetrafluoroethane (C₂H₂F₄), trifluoroacetic acid, triflic acid, hexafluorosilicates, hexafluorophosphates, tetrafluoroaluminates, alkali (Group 1) fluorides, alkaline earth (Group 2) fluorides, Group 4 fluorides, Group 6 fluorides, Group 8-13 fluorides, lanthanide fluorides, and a combination thereof.

In some embodiments, the mixture includes between 2% and 10% (w/w %) of the fluoride source. In some embodiments, the mixture includes between 2.8% and 5.9% (w/w %) of the fluoride source. In some embodiments, the mixture includes about 2.8% (w/w %) of the fluoride source. In some embodiments, the mixture includes about 4.4% (w/w %) of the fluoride source. In some embodiments, the mixture includes about 5.6% (w/w %) of the fluoride source. In some embodiments, the mixture includes about 5.9% (w/w %) of the fluoride source.

In some embodiments, the fluoride mineralizing agent is ammonium bifluoride (NH₄HF₂). In some embodiments, the mixture includes about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, about 5%, about 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, about 8%, about 8.1%, about 8.2%, about 8.1%, about 8.4%, about 8.5%, about 8.6% about 8.7%, about 8.8%, about 8.9%, about 9%, about 9.1%, about 9.2%, about 9.3%, about 9.4%, about 9.5%, about 9.6%, about 9.7%, about 9.8%, about 9.9%, or about 10% (w/w %) fluoride source, for example ammonium bitluoride.

If desired, one or more optional additives may be included when preparing a fluoride-mineralized carrier. For example, it may be desirable to include one or more additives to facilitate in forming a formed body and/or to alter one or more of the characteristics of the resulting fluoride-mineralized carrier. Suitable additives may include any of the wide variety of known carrier additives, which include, but are not limited to: bonding agents, e.g., polyolefin oxides, celluloses, alkaline earth metal compounds, such as magnesium silicate and calcium silicate, and alkali metal compounds; extrusion aids, e.g., petroleum jelly, hydrogenated oil, synthetic alcohol, synthetic ester, glycol, starch, polyolefin oxide, polyethylene glycol, and mixtures thereof; solvents, e.g., water; peptizing acids, e.g., a monofunctional aliphatic carboxylic acid containing from 1 to about 5 carbon atoms, such as formic acid, acetic acid, and/or propanoic acid; a halogenated monofunctional aliphatic carboxylic acid containing from 1 to about 5 carbon atoms, such as mono-, di-, and trichloro acetic acid, etc.; fluxing agents, binders, dispersants, burnout materials, also known as “pore formers”, strength-enhancing additives, etc. It is within the ability of one skilled in the art to select suitable additives in appropriate amounts, taking into consideration, for example, the preparation method and the desired properties of the resulting fluoride-mineralized ceramic material carrier.

In some embodiments, the process includes the use of formic acid. Formic acid may function to stabilize the particles' dispersion in the mixture. In some embodiments, formic acid is added to the mixture at about 1% (w/w %), about 1.5% (w/w %), about 2% (w/w %), about 2.5% (w/w %), about 3% (w/w %), about 3.5% (w/w %), about 4% (w/w %), about 4.5% (w/w %), about 5% (w/w %), about 5.5% (w/w %), about 6% (w/w %), about 6.5% (w/w %), about 7% (w/w %), or about 7.5% (w/w %).

In some embodiments, the mixture further includes one or more thermally decomposable materials. The mixture may contain a quantity of thermally decomposable material of from about 2% (w/w %) to about 40% (w/w %), or in the range of from about 5% (w/w %) to about 30% (w/w %). A thermally decomposable material may function as a pore former. As used herein, the thermally decomposable material is a solid in particulate form. The thermally decomposable material is mixed with a heat sinterable material prior to the heating step, for example with a greenware mix of titania dioxide. Individual particles of thermally decomposable material occupy a multitude of small spaces in the mixture. The individual particles of thermally decomposable material are removed by thermal decomposition during the heating step and/or sintering step, thereby leaving pores in the ceramic material forming the carrier. The pores may also be described as a plurality of voids distributed throughout the carrier. The thermally decomposable material should not be soluble in any of the other ingredients used to make the carrier. Similarly, the thermally decomposable material should not dissolve any of the other ingredients. Because the thermally decomposable material occupies a volume prior to the heating step and the spaces occupied by the material remain generally unoccupied after the heating step has been. completed, the material functions as a pore former. The thermally decomposable material useful in a process of this invention is typically an organic material. Suitably the chemical formula of the organic material comprises carbon and hydrogen. The thermally decomposable material may be a synthetic or a naturally occurring material or a mixture of the same. Preferably, the thermally decomposable material may be an organic material that has a decomposition temperature which is no greater than the sintering temperature of the heat sinterable material. This insures that the thermally decomposable material is at least partly removed prior to or simultaneously with the sintering of the heat sinterable material. To facilitate decomposition, the chemical formula of the thermally decomposable material may preferably comprise carbon, hydrogen and oxygen. The decomposition temperature may be lowered by the presence of oxygen.

In some embodiments, the mixture further includes one or more naturally occurring thermally decomposable materials that result in the formation of pores during burnout. As used herein, naturally occurring thermally decomposable materials does not include the polymers in the formulation and does not include other processing aides. Rather, naturally occurring thermally decomposable materials refers to burnout materials optionally included when preparing a titanium dioxide fluoride mineralized carrier to facilitate the shaping of a formed body and/or to alter the porosity of a resulting titanium dioxide ceramic material carrier. Typically, burnout materials are burned out, sublimed, or volatilized during drying, calcining, and/or sintering. Examples of suitable burnout materials include, but are not limited to, comminuted shells of nuts such as pecan, cashew, walnut, peach, apricot and filbert. Any other naturally occurring thermally decomposable materials known in the art can be used. In some embodiments, no more than 0.1 mL/g of pore volume in the resulting ceramic material is due to the use of burnout material. In some embodiments, no naturally occurring thermally decomposable materials are included in the mixture.

The thermally decomposable material may be a synthetic material. The synthetic material may be a polymer material. Without wishing to be bound by any particular theory, and as used herein, synthetic materials are contemplated not to include naturally occurring thermally decomposable materials. The polymer material may be formed using an emulsion polymerization, including suspension polymerization, which is often preferred since the polymer can be obtained in the form of fine particles that are directly usable as thermally decomposable material. Preferably, the polymer material may be formed using anionic polymerization. The polymer material may be olefin polymers and copolymers, for example polyethylene, polypropylene, polystyrene, polyvinyl alcohol, ethylene-vinyl acetate and ethylene-vinyl alcohol copolymers, diene polymers and copolymers such as polybutadiene, EPDM rubber, styrene-butadiene copolymers and butadiene-acrylonitrile rubbers, polyamides such as polyamide-6, and polyamide-66, polyesters such as polyethylene terephthalate. Preferably, the polymer material may be hydrocarbon polymers such as polyolefins, more preferably polypropylene.

The thermally decomposable material may be screened or otherwise sorted to limit the size of the individual particles to a specific particle size range. If desired, a first thermally decomposable material, having particles within a first particle size range, may be combined with a second thermally decomposable material, having particles within a second particle size range, to obtain a multimodal distribution of pore sizes in the porous ceramic material of the carrier. The limitations on a particle size range are determined by the size of the pores to be created in the porous ceramic material of the carrier.

In some embodiments, the mixture further includes one or more polymers or copolymers selected from hydroxypropyl methylcellulose, a vinyl chloride copolymer, a vinyl acetate copolymer, an olefin polymer, an olefin copolymer, polyethylene, polypropylene, polystyrene, polyvinyl alcohol, an ethylene-vinyl acetate copolymer, an ethylene-vinyl alcohol copolymer, a diene polymer, a diene copolymer, polybutadiene, an ethylene propylene diene monomers (EPDM) rubber, a styrene-butadiene copolymer, a butadiene acrylonitrile rubber, a polyamide, polyamide-6, polyamide-66, a polyester, polyethylene terephthalate, a hydrocarbon polymer, a polyolefin, and polypropylene. The one or more polymers or copolymers may function as lubricants and/or pore formers.

The carrier bodies may be formed from the mixture by any convenient molding process, such as spraying, spray drying, agglomeration or pressing, and preferably they are formed by extrusion of the mixture. For applicable methods, reference may be made to, for example, U.S. Pat. Nos. 5,145,824, 5,512,530, 5,384,302, 5,100,859, and 5,733,842, which are herein incorporated by reference. To facilitate such molding and/or extrusion processes, in particular extrusion, the mixture may suitably be compounded with up to about 30% w/w and preferably from 2 to 25% w/w, based on the weight of the mixture, of processing aids. Processing aids, also referred to by the term “extrusion aids,” are known in the art, as described for example in “Kirk-Othmer Encyclopedia of Chemical Technology,” 4th edition, Volume 5, p. 610. Suitable processing aids are typically liquids or greasy substances, for example petroleum jelly, hydrogenated oil, synthetic alcohol, synthetic ester, glycol, or polyolefin oxide. Boric acid may also be added to the mixture, for example in a quantity of up to 0.5% w/w %, more typically in a quantity of from 0.01 to 0.5% w/w %.

In some embodiments, the process further includes extruding the mixture before sintering. In some embodiments, the process further includes forming the mixture into one or more discrete bodies before sintering, for example the mixture may be formed into carrier bodies. In general, the size of the carrier bodies is determined by the dimensions of the reactor in which they are to be deposited. Generally, however, it is found very convenient to use carrier bodies in the form of powdery particles, trapezoidal bodies, cylinders, saddles, spheres, doughnuts, and the like. The cylinders may be solid or hollow, straight or bent, and they may have their length from 4 to 20 mm, typically from 5 to 15 mm, their outside diameter from 4 to 20 mm, typically from 5 to 15 mm, and their inside diameter from 0.1 to 6 mm, typically from 0.2 to 4 mm. The cylinders may have a ratio of length to outside diameter in the range of from 0.5 to 2, typically from 0.8 to 1.2.

The formed parts can be produced in a variety of shapes such as cylindrical, spherical, annular, or trilobe. For example, shaped pellets may be formed by extruding a continuous rod of the paste and then cutting the rod into pellets of the desired size. Ring-based shaped structures of any desired configuration such as “wagon wheels” or any other extruded shapes with constant cross-sections such as for example multi-lobed structures and small honeycombs may be formed by extruding the paste through a suitably shaped die and then cutting to the rod into pellets of a constant cross section. The shaped articles may also be in the form of large honeycomb monoliths. However, the extrusion/pressing process is not limited to these shapes. The parts may have an outer diameter, or average width when non-circular, of from about 0.8 to about 25 mm, although other sizes may be formed. Reference may be made to U.S. Patent Pub. No. 2012/0171407 incorporated by reference herein, for further description of multi-lobed carriers.

Additionally, the size of the fluoride-mineralized titanium dioxide ceramic material carrier is generally not limited, and may include any size suitable for use in a catalytic reactor, for example a Fischer-Tropsch reactor. For example, a fluoride-mineralized titanium dioxide ceramic material carrier may be in the shape of a cylinder having a length of 5 to 15 millimeters, an outside diameter of 5 to 15 mm, and an inside diameter of 0.2 to 4 mm. In some embodiments, the fluoride-mineralized titanium dioxide ceramic material carrier may have a length-to-outside diameter ratio of 0.8 to 1.2. Additionally, the fluoride-mineralized titanium dioxide ceramic material carrier may be in the shape of a hollow cylinder with a wall thickness of 1 to 7 mm. It is within the ability of one skilled in the art, with the benefit of this disclosure, to select a suitable shape and size of a fluoride-mineralized titanium dioxide ceramic material carrier, taking into consideration, for example, the type and configuration of the catalytic reactor in which the fluoride-mineralized titanium dioxide ceramic material carrier will be employed, e.g., the length and internal diameter of the tubes within the catalytic reactor.

In some embodiments, the process further includes drying the mixture. The thrilled carrier bodies may be dried to remove at least a portion of the water present, if any. Water might convert to steam during the heating step, described hereinafter, and adversely affect the physical integrity of the shaped bodies. The drying may occur after the preparation of the mixture and optional forming of the mixture into a plurality of shaped bodies. The drying step may be combined with the heating step by controlling the thermal profile of the oven or kiln. Drying may take place between 20 and 400° C., or between 30 and 300° C., typically for a period of up to 100 hours and preferably for from 5 minutes to 50 hours. Typically, drying is performed to the extent that the mixture contains less than 2% w/w % of water.

Calcination and/or sintering is generally conducted at a temperature that is high enough, and for a period of time that is sufficiently long enough, to induce mineralization of at least a portion of the titanium dioxide starting material. In some embodiments, calcination and/or sintering may be conducted at one or more temperatures, at one or more pressures, and for one or more time periods, sufficient to convert at least 50%, or at least 75%, or at least 85%, or at least 90% or at least 95% of the amorphous titanium dioxide. In some embodiments, the process includes heating the mixture at a temperature of at least 900° C. In some embodiments, the process includes heating the mixture at a temperature of up to 1100° C. In some embodiments, the process includes heating the mixture at a temperature of between about 950° C. and about 1050° C. In some embodiments, the process includes heating the mixture at a temperature of about 950° C., about 1000° C., or about 1050° C. Calcining and/or sintering may be carried out in any suitable atmosphere, including but not limited to, air, nitrogen, argon, helium, carbon dioxide, water vapor, those comprising a fluoride mineralizing agent and a combination thereof. However, in those embodiments where a formed body further comprises an organic burnout material, at least one of heating and/or calcining is at least partially or entirely carried out in an oxidizing atmosphere, such as in an oxygen-containing atmosphere. As used herein, sintering means the process of firing and consolidating a body from powder particles. The particles are hound to adjoining particles. Voids may exist between and/or within the particles.

After calcining and/or sintering, the resulting fluoride-mineralized titanium dioxide ceramic material carrier may optionally be washed and/or treated prior to deposition of the catalytic material. Likewise, if desired, any raw materials used to form the fluoride-mineralized titanium dioxide ceramic material carrier may be washed and/or treated prior to calcination and/or sintering. Any method known in the art for washing and/or treating may be used in accordance with the present disclosure, provided that such method does not negatively affect the performance of the resulting carrier or catalyst. Reference is made to U.S. Pat. Nos. 6,368,998, 7,232,918, and 7,741,499, which are incorporated herein by reference, for descriptions relating to such methods. If washing is desired, it is typically conducted at a temperature in the range of from 15° C. to 120° C., and for a period of time up to 100 hours and preferably from 5 minutes to 50 hours. Washing may be conducted in either a continuous or batch fashion. Examples of suitable washing solutions may include, but are not limited, water, e.g., deionized water; aqueous solutions comprising one or more salts, e.g., ammonium salts, amine solutions, e.g., ethylenediamine, aqueous organic diluents, and a combination thereof. Similarly, suitable aqueous solutions may be acidic, basic or neutral. The volume of washing solution may be such that the fluoride-mineralized titanium dioxide ceramic material carrier is impregnated until a point of incipient wetness of the carrier has been reached. Alternatively, a larger volume may be used and the surplus of solution may be removed from the wet carrier, for example, by centrifugation. Furthermore, following any washing and/or treating step, it is preferable, prior to deposition of the catalytic material, to dry or roast the fluoride-mineralized titanium dioxide ceramic material carrier. For example, the carrier may be dried in a stream of air, for example at a temperature of from 80° C. to 400° C., for a sufficient period of time.

The formed titanium dioxide ceramic material carriers can either be used directly as catalysts or as catalytic carriers after the shaped bodies have been impregnated, during or after their formation, with a solution of a catalytically active substance and optionally activated by means of suitable post-treatment. Suitable catalytically active substances include transition metal elements, such as those from groups VB, VIIIB, and IB of the periodic table of elements, e.g., vanadium, gold, platinum group metals, and others. Exemplary applications in which the carrier may be employed include the catalytic formation of amines as described, for example, in U.S. Pat. No. 5,225,600, diesel engine exhaust gas purification, as disclosed, for example, in U.S. Pat. No. 5,208,203, decomposition of organic peroxides to form alcohols, for example, using the process of U.S. Pat. No. 4,547,598, removal of peroxide contaminants from alcohol product streams, for example, according to the process of U.S. Pat. No. 5,185,480, and in the Fischer-Tropsch process, for example, as disclosed in U.S. Pat. No. 5,169,821. In some embodiments, the metal is a catalytically active metal including for example cobalt, ruthenium, and/or iron.

A number of patent and non-patent publications are cited herein in order to describe the state of the art to which this invention pertains. The entire disclosure of each of these publications is incorporated by reference herein.

The following examples describe the invention in further detail. These examples are provided for illustrative purposes only, and should in no way be considered as limiting the invention.

### EXAMPLES

Eight samples were prepared by a method described herein and included samples that did not include ABF (samples 1, 2, and 8) or did include ABF (samples 3, 4, 5, 6, and 7) (see Table 1). The greenware mix for the titanium dioxide ceramic material was made with a standard slurry mix method. Any liquid additive was added in place of water in the second liquid adding step. The mix comprises hydrated titania TiO₂.xH₂O, Methocel K4MS, formic acid, DI water, UCAR, and NH₄HF₂ (ABF).

The greenware was prepared by slurry mixing process starting with dry mixing UCAR with 60%-70% of titania at low rotor speed. Water and acid were added to the mix and rotor speed was changed to high. Once the slurry was obtained, the remaining titania and ABF were added. The mixing then continued for another 3 minutes to achieve a consistency sufficient for extrusion. The greenware was dried overnight and in an oven prior to firing.

Firing of the greenware was performed in a tubular static kiln, in part for the purpose of maintaining a fluorine atmosphere during tiring. The sample was heated to 900-1100° C. at a rate of about 5° C./min, and thereafter maintained at the maximum temperature for about 3 hours. The cooling step was set to be done as rapidly as the kiln can be cooled down without damage.

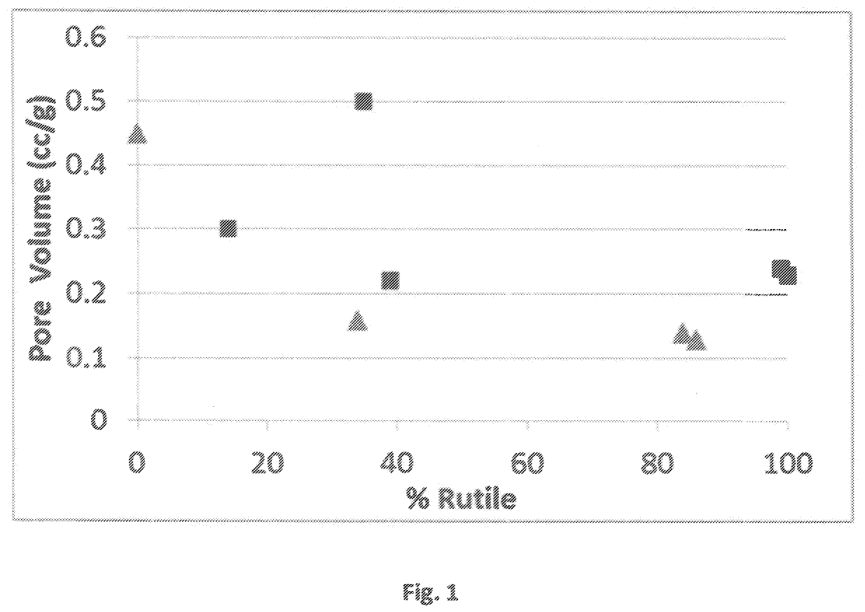

As listed in Table 1, and as shown in FIG. 1, addition of ABF resulted in an increase in the pore volume of the ceramic materials. Fireware samples made without addition of ABF, i.e., samples 1, 2, and 8, have pore volumes of 0.13, 0.16, and 0.14 cm³/g, respectively. Addition of ABF resulted in an increase in pore volume, with a direct correlation between the increase in pore volume and the amount of added ABF being observed in the range of about 4.7% to about 9.8% added ABF (w/w % of the total mixture). For example, it was observed that addition of about 4.73% (0.12 kg 60% ABF), 7.38% (0.58 kg 60% ABF), 9.28% (0.73 kg 60% ABF), and 9.84% (0.24 kg 60% ABF) to the mixture, resulted in pore volumes of 0.22, 0.23-0.24, 0.3, and 0.5 cm³/g, respectively. While addition of ABF resulted in decreases in the ceramic material crush strength relative to material made without added ABF, the crush strength was nevertheless maintained in the range of about 5.1 lbf (22.69 N) to about 33.2 lbf (147.68 N), which is a suitable range of values for catalyst carrier application.

TABLE 1

| | Greenware | | | | | | | |
|---|---|---|---|---|---|---|---|---|
| | Sample | | | | | | | |
| Raw materials | 1 | 2 | 3 | 4 | 5 | 6 | 7 | 8 |
| Hydrated titania (kg) | 1.63 | 2.21 | 1.63 | 4.88 | 4.88 | 4.88 | 1.63 | 1.63 |
| Methocel K4MS (kg) | 0.014 | 0.018 | 0.014 | 0.041 | 0.041 | 0.041 | 0.014 | 0.014 |
| Formic acid (kg) | 0.07 | 0.05 | 0.08 | 0.24 | 0.24 | 0.24 | 0.07 | 0.07 |
| DI water (kg) | 0.73 | 1.32 | 0.69 | 2.11 | 2.11 | 1.96 | 0.48 | 0.61 |
| UCAR (kg) | 0.005 | 0.005 | 0.004 | 0.012 | 0.012 | 0.012 | 0.004 | 0.00 |
| 60% NH₄HF₂ (kg) | 0.00 | 0.00 | 0.12 | 0.58 | 0.58 | 0.73 | 0.24 | 0.00 |
| Ammonium Hydroxide | 0.00 | 0.00 | 0.00 | 0.00 | 0.00 | 0.00 | 0.00 | 0.17 |
| (kg) | | | | | | | | |
| Properties | Firedware | | | | | | | |
| Firing Kiln | Static | Static | Static | Static | Static | Static | Static | Static |
| Firing temperature (° C.) | 950 | 940 | 950 | 1000 | 1050 | 950 | 950 | 950 |
| % Rutile | 86 | 34 | 39 | 99 | 100 | 14 | 35 | 84 |
| Surface area (m²/g) | 2.93 | 3.86 | 5.4 | 6.5 | 2.7 | 5.82 | 5.6 | 2.92 |
| Pore volume (cc/g) | 0.13 | 0.16 | 0.22 | 0.24 | 0.23 | 0.3 | 0.5 | 0.14 |
| Crush strength (lbf and | 47.3 lbf | 21.7 lbf | 23.9 lbf | 29.7 lbf | 33.2 lbf | 12.61 lbf | 5.1 lbf | 37.7 lbf |
| N) | (210.39N) | (96.52N) | (106.31N) | (132.11N) | (147.67N) | (56.09N) | (22.68N) | (167.69N) |

Unless defined otherwise, all technical and scientific terms used herein have the same meaning as is commonly understood by one of skill in the art to which this invention belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, from 0% to 10%, from 0% to 5%, or the like, of the stated number or numerical range.

As used herein, the term “about” means that amounts, sizes, formulations, parameters, shapes and other quantities and characteristics are not, and need not be exact, but may be approximate and/or larger or smaller, as desired, reflecting tolerances, conversion factors, rounding off, measurement error and the like, and other factors known to those of skill in the art. In general, an amount, size, formulation, parameter, shape or other quantity or characteristic is “about” or “approximate” whether or not expressly stated to be such.

The transitional terns “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All compounds, compositions, formulations, and methods described herein that embody the present invention can, in alternate embodiments, be more specifically defined by any of the transitional terms “comprising,” “consisting essentially of,” and “consisting of.” The term “comprising” (and related terms such as “comprise” or “comprises” or “having” or “including”) includes those embodiments such as, for example, an embodiment of any composition of matter, method, or process that “consist of” or “consist essentially of” the described features.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

What is claimed is:

1. A porous ceramic material comprising a plurality of sintered ceramic titanium dioxide particles, the material having a pore volume (PV) between 0.20 and 0.60 mL/g and a crush strength (CS) of no less than 3 lbf, wherein at least 10% (w/w) of said titanium dioxide is rutile phase.

2. The ceramic material of claim 1, wherein at least 15% (w/w %) of said titanium dioxide is rutile phase.

3. The ceramic material of claim 1, wherein at least 35% (w/w %) of said titanium dioxide is rutile phase.

4. The ceramic material of claim 1, wherein at least 50% (w/w %) of said titanium dioxide is rutile phase.

5. The ceramic material of claim 1, wherein the material has a surface area between 2 and 10 m²/g.

6. A porous ceramic material comprising a plurality of sintered ceramic titanium dioxide particles, the material having a pore volume (PV) between 0.20 mL/g and 0.50 mL/g, and a crush strength (CS) between 5 lbf and 35 lbf, wherein at least 14% of said titanium dioxide is rutile phase.

7. The ceramic material of claim 6, wherein at least 35% of said titanium dioxide is rutile phase.

8. The ceramic material of claim 6, wherein at least 80% of said titanium dioxide is ruffle phase.

9. A process of making a porous ceramic material, the process comprising the steps of:
preparing a mixture comprising (w/w %): titanium dioxide (45% to 70%), water (10% to 40%), a fluoride source (2% to 15%), and an acid (1% to 7.5%); and
sintering the mixture.

10. The process of claim 9, wherein the fluoride source is ammonium bifluoride.

11. The process of claim 9, wherein the mixture comprises between 2.5% and 6% of the fluoride source.

12. The process of claim 9, wherein the mixture comprises about 4.4% of the fluoride source.

13. The process of claim 9, wherein the mixture comprises about 5.6% of the fluoride source.

14. The process of claim 9, wherein the mixture comprises about 5.9% of the fluoride source.

15. The process of claim 9, wherein the mixture further comprises one or more naturally occurring thermally decomposable materials.

16. The process of claim 9, wherein the acid is formic acid.

17. The process of claim 9, further comprising extruding the mixture before sintering.

18. The process of claim 9, further comprising forming the mixture into one or more discrete bodies before sintering.

19. The process of claim 9, further comprising drying the mixture.

20. The process of claim 9, further comprising heating the mixture at a temperature of at least 900° C.
